(19) United States
(12) Patent Application Publication
(10) Pub. No.: US 2010/0052920 A1
(43) Pub. Date: Mar. 4, 2010

(54) ALARM SYSTEM FOR BATHTUB

(76) Inventor: Reynold Roach, Brooklyn, NY (US)

Correspondence Address: JAY M. SCHLOFF, 6960 Orchard Lake Road, Suite 315, West Bloomfield, MI, 48322, US

(21) Appl. No.: 12/200,667

(22) Filed: Aug. 28, 2008

(51) Int. Cl. G08B 21/00

(52) U.S. Cl. 340/618

(57) ABSTRACT

Disclosed is an alarm system for a bathtub configured to alert ascension of water up to a predetermined level in the bathtub. The alarm system comprises a sensing device configured at a predetermined level on a sidewall of the bathtub and a detector communicably coupled to the sensing device. The sensing device is adapted to generate an electrical signal upon ascension of water in the bathtub up to the predetermined level. The detector is adapted to be activated by the electrical signal generated by the sensing device to generate an alert.

### FIELD OF THE INVENTION

The present invention relates generally to an alarm system, and more particularly, to an alarm system for a bathtub to alert ascension of water reaching a hazardous or dangerous level within the bathtub.

### BACKGROUND OF THE INVENTION

A bathtub is a plumbing fixture used for bathing. Typically, the bathtub is installed inside a bathroom either as a standalone fixture or in conjunction with a shower. A conventional bathtub includes a tub, a faucet for supplying water into the tub, and a drainage assembly for removing water from the tub. The drainage assembly includes a drain hole and a cap configured to close the drain hole.

A drainage assembly of the conventional bathtub may be manufactured to include a trip lever configured to remove excessive water from the bathtub. Although the conventional bathtubs are provided with the drainage assembly to drive out excess water out of the bathtub, the flow rate of water from the faucet into the tub may exceed the rate at which the excess water is driven out of the bathtub, thereby causing an overflow of the excess water. Such overflow of water from sides of the bathtub may be hazardous to life of the user using the bathtub. Moreover, such overflow of water may lead to accidents in the bathroom area, thereby injuring the user or any other person in the vicinity thereof.

In certain circumstances, the user may get engrossed in a different activity and inadvertently forget to close the faucet, due to which such excess water may overflow from the sides of the bathtub. The problem may be aggravated when the bathtub is used by children or elderly persons for bathing. Research has shown that inadvertently forgetting to monitor overflow of excess water in the bathtub has been a cause of danger to life of many users especially, children and elderly persons.

Further, people may differ in preferences thereof for taking bath. More specifically, some people may prefer to take bath with cold water while others prefer to take bath with lukewarm or warm water. Accordingly, the faucet of a conventional bathtub is configured to provide a supply of cold water as well as hot water, so that a user taking a bath may mix the cold water with the hot water to obtain the required temperature of water for bathing. However, a wrong estimation of the temperature of the water in the bathtub may lead to accidents, such as causing burns to the users taking bath. There is a potential risk for children and elderly persons who are unable to correctly check the temperature of the water in the bathtub.

Accordingly, there is a need for alerting a user when water level in the bathtub reaches a certain predetermined level. Moreover, there is a need for alerting the user when temperature of water in the bathtub rises above a certain predetermined temperature.

### SUMMARY OF THE INVENTION

In view of the foregoing disadvantages inherent in the prior art, the general purpose of the present invention is to provide an alarm system for a bathtub configured to include all the advantages of the prior art, and to overcome the drawbacks inherent therein.

Accordingly, an object of the present invention is to provide an alarm system for a bathtub that is configured to alert a user when water level in the bathtub reaches a certain predetermined level.

Another object of the present invention is to provide an alarm system for a bathtub that is readily adaptable with different types of bathtubs.

Still another object of the present invention is to provide an alarm system for a bathtub that is configured to alert a user when temperature of water in the bathtub rises above a certain predetermined temperature.

In light of the above objects, in one aspect of the present invention, an alarm system for a bathtub configured to alert ascension of water up to a predetermined level is disclosed. The alarm system comprises a sensing device configured at a predetermined level on a sidewall of the bathtub and a detector communicably coupled to the sensing device. The sensing device is adapted to generate an electrical signal upon ascension of water in the bathtub up to the predetermined level. The detector is adapted to be activated by the electrical signal generated by the sensing device to generate an alert upon ascension of water in the bathtub up to the predetermined level.

In another aspect of the present invention, an alarm system for a bathtub is disclosed that is configured to alert a user when temperature of water in the bathtub rises above a certain predetermined temperature.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawing and descriptive matter in which there are illustrated exemplary embodiments of the present invention.

### BRIEF DESCRIPTION OF THE DRAWING

The advantages and features of the present invention will become better understood with reference to the following detailed description and claims taken in conjunction with the accompanying drawing, and in which:

FIG. 1 illustrates an alarm system in conjunction with a bathtub, in accordance with an embodiment of the present invention.

### DETAILED DESCRIPTION OF THE INVENTION

The exemplary embodiments described herein detail for illustrative purposes are subject to many variations in structure and design. It should be emphasized, however, that the present invention is not limited to a particular alarm system for a bathtub, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The present invention provides an alarm system configured to alert a user when water in the bathtub reaches a certain predetermined level. Further, the present invention is configured to alert the user upon rise of temperature above a certain predetermined temperature. The present invention finds its utility with all types of bathtubs at multitude of places such as homes and commercial places, including hotels.

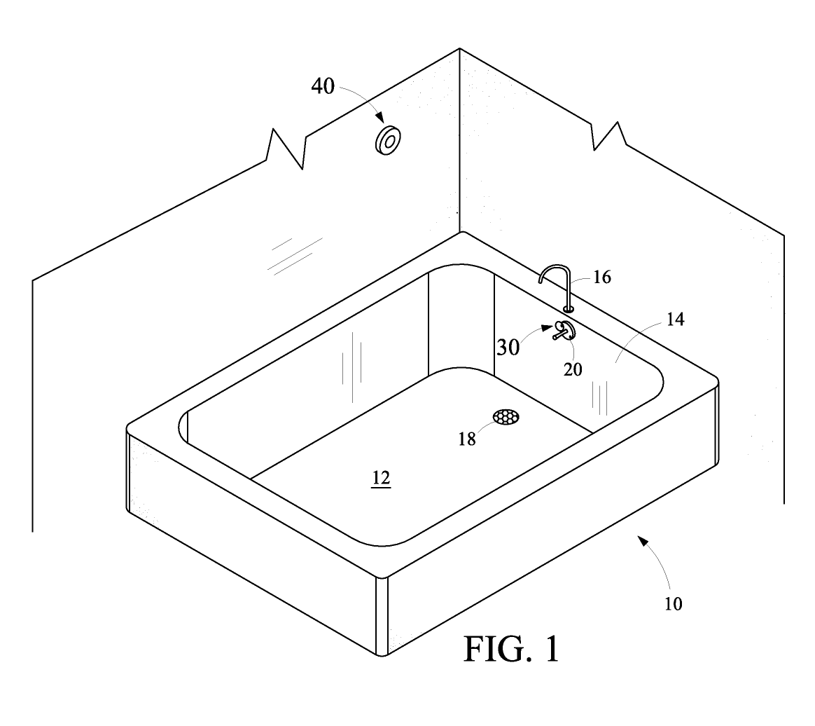

FIG. 1 illustrates an alarm system in conjunction with a bathtub 10, in accordance with an embodiment of the present invention. The alarm system includes a sensing device 30 configured on the bathtub 10, and a detector 40 readily adaptable to be mounted at any conspicuous place outside the bathtub 10, such as a wall of a bathroom. In FIG. 1, the detector 40 is shown mounted on a wall of the bathroom. However, it will be evident to a person skilled in the art that the detector 40 may be mounted at any place in the bathroom such as roof of the bathroom.

As disclosed herein, the bathtub 10 may be a conventional bathtub having a base portion 12, a plurality of sidewalls, such as a sidewall 14, and a faucet 16 configured on the sidewall 14. The bathtub 10 may further include a drain hole 18 configured on the base portion 12, and a trip lever 20 configured on the sidewall, such as the sidewall 14. The bathtub 10 is described and illustrated herein to assume a rectangular structure. However, it will be evident to a person skilled in the art that the bathtub 10 may assume any other shape, such as a circular shape, an oval shape, a polygonal shape and the like, without departing from the scope of present invention.

Referring to FIG. 1, a sidewall of the plurality of sidewalls may have the sensing device 30 configured thereon. For example, the sidewall 14 of the bathtub 10 may have the sensing device 30 configured thereon at a predetermined distance from the base portion 12. The distance of the sensing device 30 from the base portion 12 may be determined based on a user of the bathtub. For example, for use by a child, the distance of the sensing device 30 from the base portion 12 may be lower as compared to the distance when the bathtub is used by an elderly person. In the present embodiment, the sensing device 30 is mounted on the trip lever 20. The sensing device 30 may be mounted on the trip lever 20 by any of the methods known in the art, such as, by using bolts of the trip lever 20. Alternatively, the sensing device 30 may be attached to the trip lever 20 by an attachment means such as an adhesive.

As disclosed herein, the sensing device 30 includes at least one sensor such as a water level sensor (not shown). The water level sensor is configured to sense a level of water in the bathtub 10. In an embodiment of the present invention, the sensing device 30 may include a temperature level sensor configured to sense temperature of water in the bathtub 10. The sensing device 30 may be made of a waterproof material and may be airtight in order to prevent weathering thereof.

Further, the sensing device 30 may be provided with a power source (not shown) such as a battery to provide requisite electrical energy for working of the at least one sensor. In an embodiment of the present invention, the sensing device 30 may include operating mechanism (not shown) such as a switch button for activating and deactivating the alarm system. In yet another embodiment of the present invention, the sensing device 30 may include a thermometer for sensing the temperature of the water.

The sensing device 30 is capable of generating electrical signal as the water in the bathtub 10 reaches the predetermined level at which the sensing device 30 is mounted. In one embodiment of the present invention, the sensing device 30 is capable of generating electrical signals when the temperature of the water in the bathtub 10 reaches a certain predetermined temperature. The predetermined temperature may be adjusted as per the preference of a person taking the bath in the bathtub 10.

The detector 40 is communicably coupled to the sensing device 30. More specifically, the detector 40 may receive wireless electrical signals from the sensing device 30. The detector 40 may be removably mounted at any conspicuous place in the bathroom. The detector 40 includes a signal receiver (not shown) for receiving the wireless electrical signals from the sensing device 30, a power source such as a battery for providing requisite electrical energy for operating the detector 40, and an alarm sounder (not shown). The alarm sounder is capable of generating an alert. In the present embodiment, the alert may be an audible alarm signal. However, it will be evident to a person skilled in the art that the alert may be of any other type also such as visual signal and the like.

In use, the sensing device 30 may be mounted with the trip lever 20 of the bathtub 10. The detector 40 may be mounted at any conspicuous place in the bathroom such as the wall or the roof of the bathroom and is configured to receive wireless electrical signals from the sensing device 30. Water from the faucet 16 may be received in the bathtub 10 to fill the bathtub 10. As the water in the bathtub 10 reaches the predetermined level of the sensing device 30, the sensing device 30 may generate electrical signals which may be wirelessly communicated to the detector 40. Upon receiving the electrical signal, the detector may be activated to generate the alert. The alert may be the audible alarm signal warning about the rise of water level in the bathtub 10 to the predetermined level. Moreover, while filling the bathtub 10 with warm/hot water, the sensing device 30 may sense the temperature of water. If the sensing device 30 determines that the temperature of water has reached a predetermined temperature, the sensing device 30 may wirelessly transmit electrical signals to the detector 40. The detector 40, in turn may be activated to generate the alert.

The alarm system of the present invention facilitates generation of an alert in case of ascension of water in the bathtub up to the predetermined level or the ascension of temperature of the water in the bathtub above the predetermined temperature. Further, the overall configuration of the alarm system facilitates easy installation of the alarm system with any type of the bathtub known in the art. Moreover, the alarm system helps to ward off the danger associated with the use of the bathtubs, especially for children and elderly persons. Additionally, transmission of electrical signals wirelessly for generation of alarm prevents risks associated with the use of wires.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and thereby enable others skilled in the art to best utilize the present invention and various embodiments with various modifications as are suited to the particular use contemplated. It is understood that various omissions and substitutions of equivalents are contemplated as circumstances may suggest or render expedient, but such are intended to cover the application or implementation without departing from the spirit or scope of the claims of the present invention.

What is claimed is:

1. An alarm system for a bathtub, the alarm system comprising:
a sensing device configured at a predetermined level on a sidewall of the bathtub, the sensing device adapted to generate an electrical signal upon ascension of water in the bathtub up to the predetermined level; and
a detector communicably coupled to the sensing device, the detector adapted to be activated by the electrical signal generated by the sensing device to generate an alert upon ascension of water in the bathtub up to the predetermined level.

2. The alarm system of claim 1, wherein the sensing device comprises a water level sensor for sensing ascension of water in the bathtub.

3. The alarm system of claim 2, wherein the sensing device further comprises a temperature level sensor adapted to generate an electrical signal upon ascension of temperature of the water in the bathtub to a predetermined temperature.

4. The alarm system of claim 1, wherein the alert generated by the detector is an audible alarm signal.
